(19) United States
(12) Patent Application Publication
(10) Pub. No.: US 2013/0163029 A1
(43) Pub. Date: Jun. 27, 2013

(54) DEVICE-RESIDENT WEB SERVICE USING LIMITED OPERATIONAL CONDITION DATA TO PRODUCE CORRECTIVE SOLUTION TO OPERATIONAL PRINTER ERROR

(71) Applicant: Karl J. Sieburg, Rochester, NY (US)

(72) Inventor: Karl J. Sieburg, Rochester, NY (US)

(73) Assignee: XEROX CORPORATION, Norwalk, CT (US)

(21) Appl. No.: 13/336,026

(22) Filed: Dec. 23, 2011

(51) Int. Cl. G06K 15/02

(52) U.S. Cl. 358/1.14

(57) ABSTRACT

Methods and systems detect an operational error of a printing machine and execute a printer device-resident web service to cause a processor of the printing device to send trap data to an external computerized device through a network. The processor responds to a limited request made by the external computerized device with operational condition data only from identified ones of printing device sensors. The external computerized device provides a corrective solution to prevent the operational error from recurring. The processor alters at least one setting of the printing machine as directed by the corrective solution.

### BACKGROUND

Embodiments herein generally relate to solutions for operational printer errors that executes a device-resident web service to cause an external computerized device to formulate a limited request for operational condition data from the sensors of a printing machine, where the external computerized device determines the cause of the operational error to produce a corrective solution to prevent the operational error from recurring in the future.

After an operational printing error, a trap is sent from a printer or other networked devices to device management software to indicate that an event took place on the printing device. The packet cannot be interrogated for any further data, which requires the device management software to do a full status poll of the printing device (read all applicable OID (object identifier) values) in order to determine the cause of the operational error. Generally, traps are sent when a problem has occurred with a printing device. Since the device management software has to do a full status poll, the problem can take a relatively long time to be identified and rectified. In addition, the full status polling can create more network chatter and slow down network traffic.

### SUMMARY

An exemplary system herein includes a printing machine that has a processor, sensors operatively connected to the processor, a non-transitory storage medium operatively connected to the processor, and a network connection operatively connected to the processor. The system also includes an external computerized device operatively connected to the network connection through a network. The external computerized device comprising a device that is physically separate from the printing machine. Further, a device-resident web service is stored on the non-transitory storage medium. The device-resident web service comprises a program of instructions executable by the processor.

The processor may periodically detect an operational error of the printing machine. The processor stores, in the non-transitory storage medium, trap data when such an operational error is detected. The trap data comprises information that the processor detected to identify the operational error. When such an operational error is detected, the processor then executes the device-resident web service to cause the processor to send the trap data to the external computerized device through the network that is connected to the network connection of the printing machine.

The external computerized device analyzes the trap data to formulate a limited request for operational condition data from the sensors of the printing machine. The limited request is for operational condition data only from identified ones of the sensors that relate to the trap data (less than all sensors within the printing machine). The external computerized device sends the limited request to the processor through the network.

The processor then responds, through the network to the external computerized device. More specifically, the processor then responds to the limited request with operational condition data only from the identified ones of the sensors (by following the program of instructions of the device-resident web service). The external computerized device then determines the cause of the operational error from the operational condition data from the identified sensors to produce a corrective solution to prevent the operational error from recurring in the future. The external computerized device then sends the corrective solution to the processor through the network. The processor can then alter at least one setting of the printing machine (a non-volatile memory setting within the printing machine) as directed by the corrective solution.

An exemplary method first installs a device-resident web service on the non-transitory storage medium of the printing machine. The method detects (using the processor) an operational error of the printing machine and stores trap data in the non-transitory storage medium when the operational error is detected. The trap data comprises information that the processor detected to identify the operational error.

When the operational error is detected the method executes (using the processor) the device-resident web service to cause the processor to send the trap data to the external computerized device through the network connected to the network connection of the printing machine. The method next analyzes (using the external computerized device) the trap data to formulate a limited request for operational condition data from sensors of the printing machine. The limited request asks for operational condition data only from identified ones of the sensors that relate to the trap data. The method then sends the limited request from the external computerized device to the processor through the network.

The method then responds (using the processor through the network to the external computerized device) to the limited request with operational condition data only from the identified ones of the sensors. The method determines (using the external computerized device) a cause of the operational error from the operational condition data from the identified sensors to produce a corrective solution to prevent the operational error from recurring. Next, the method sends, from the external computerized device, the corrective solution to the processor through the network. This allows the method to alter (using the processor) at least one setting of the printing machine as directed by the corrective solution.

These and other features are described in, or are apparent from, the following detailed description.

### BRIEF DESCRIPTION OF THE DRAWINGS

Various exemplary embodiments of the systems and methods are described in detail below, with reference to the attached drawing figures, in which:

FIG. 1 is a block schematic diagram of a device according to embodiments herein;

FIG. 2 is a block schematic diagram of a device according to embodiments herein;

FIG. 3 is a block schematic diagram of a system according to embodiments herein; and

FIG. 4 is a block schematic diagram of a device according to embodiments herein;

### DETAILED DESCRIPTION

As mentioned above, because the device management software has to do a full status poll when a printing error occurs, the problem can take a relatively long time to be identified and rectified. In view of this, methods and systems herein connect to a web service running on the device that sent the trap. The web service quickly produces a list of any issues with the device, instead of re-polling the device for all relevant OID values. The device management software can then make an informed decision on what settings need to be changed in order to bring the device back into a good state. The methods and systems herein provide a quick way to resolve any issues with a device in a managed environment. These technologies can use any protocol, such as the SNMP protocol, and a web service framework such as Microsoft's Windows Communication Foundation.

With methods and systems herein the SNMP trap serves to simply signal to the device management software that there is a problem with the device sending the trap. The problem can be anything ranging from an authentication failure, a configuration error, or any other event of concern that may occur with a device. Once the trap is received by the device management software, the software connects to a web service that is running at a known location on the device. The address of the web service can be at a fixed location, such as https://[Printer's IP Address]/TrapService.svc. The location can depend on the implementation and endpoint used.

Once the device management software connects to the device, the external computerized device will request and receive a limited serialized object detailing all of the relevant data for the event that triggered the trap, instead of re-polling the device for all relevant OID values. The external computerized device can then process this serialized object using internal programmed logic to determine what appropriate steps to take.

This provides the ability to quickly diagnose an issue with a device without having to read all possible OID values to determine the state of the device. This provides quicker response time to device problems and reduces network traffic.

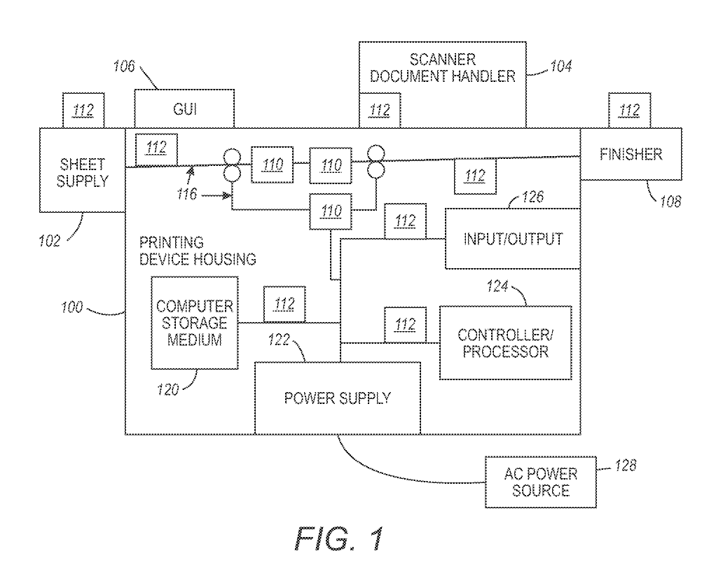

FIG. 1 illustrates a computerized printing device 100, according to embodiments herein and can comprise, for example, a printer, copier, multi-function machine, etc. The printing device 100 includes a controller/processor 124, at least one marking device (printing engines) 110, 112, 114 operatively connected to the processor 124, a media path 116 positioned to supply sheets of media from a sheet supply 102 to the marking device(s) 110, and a communications port (input/output) 126 operatively connected to the processor 124 and to a computerized network external to the printing device. After receiving various markings from the printing engine(s), the sheets of media can optionally pass to a finisher 108 which can fold, staple, sort, etc., the various printed sheets.

Also, the printing device 100 can include at least one accessory functional component (such as a scanner/document handler 104, sheet supply 102, finisher 108, etc.) and graphic user interface assembly 106 that also operate on the power supplied from the external power source 128 (through the power supply 122).

The input/output device 126 is used for communications to and from the multi-function printing device 100. The processor 124 controls the various actions of the printing device. A non-transitory computer storage medium device 120 (which can be optical, magnetic, capacitor based, etc.) is readable by the processor 124 and stores instructions that the processor 124 executes to allow the multi-function printing device to perform its various functions, such as those described herein.

Thus, a printer body housing 100 has one or more functional components that operate on power supplied from the alternating current (AC) 128 by the power supply 122. The power supply 122 connects to an external alternating current power source 128 and converts the external power into the type of power needed by the various components.

The printing machine 100 also includes various sensors 112 operatively connected to the processor 124. Further, a printer device-resident web service is stored on the non-transitory storage medium 120 of the printing machine 100. The device-resident web service comprises a program of instructions executable by the processor 124.

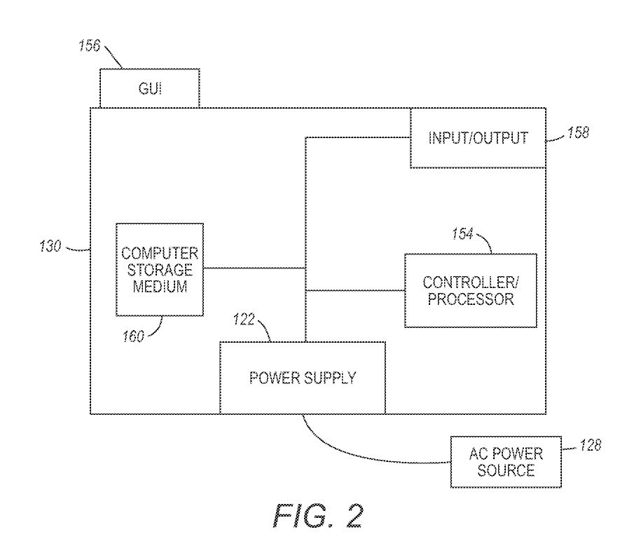

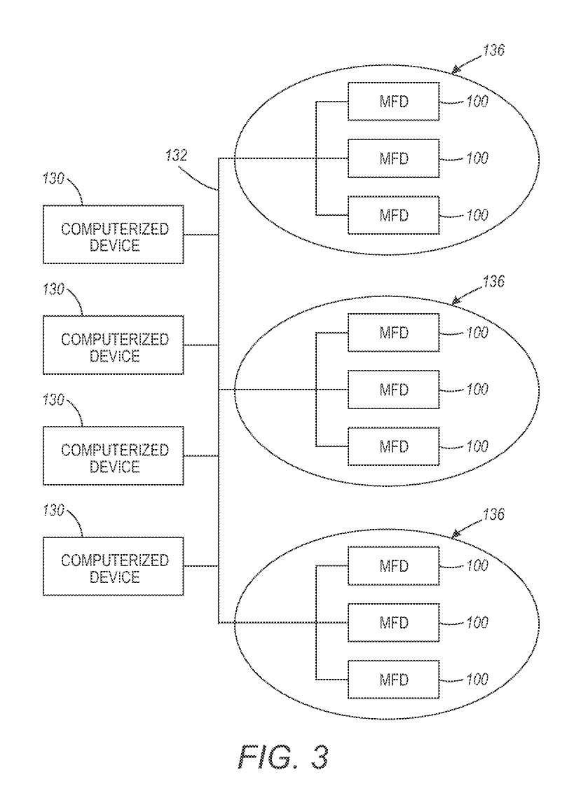

As shown in FIGS. 2 and 3, the system also includes an external computerized device 130 operatively connected to a network connection 126 through a network 132. The external computerized device 130 comprising a device that is physically separate from the printing machine 100 and can, as shown in FIG. 3, be more than one device, and can be connected to multiple printing machines 100 that may be grouped at various client sites 136.

Each computerized device 130 similarly includes a controller/processor 154, a communications port (input/output) 158 operatively connected to the processor 154 and to a computerized network external to the printing device, and a graphic user interface assembly 156, all that that operate on the power supplied from the external power source 128 (through the power supply 122). A similar non-transitory computer storage medium device 160 (which can be optical, magnetic, capacitor based, etc.) is readable by the processor 154 and stores instructions that the processor 154 executes to allow the computerized device 130 to perform its various functions, such as those described herein.

The processor 124 of the printing machine 100 may periodically detect an operational error or other type of out of normal operating specification “event” of the printing machine 100. The processor 124 stores, in the non-transitory storage medium 120, trap data when such an operational error is detected. The trap data comprises information that the processor 124 detected to identify the operational error. When such an operational error is detected, the processor 124 then executes the device-resident web service to cause the processor 124 to send the trap data to the external computerized device 130 (through the network 132 that is connected to the network 132 connection of the printing machine).

The external computerized device 130 analyzes the trap data to formulate a limited request for operational condition data from the sensors 112 of the printing machine. The limited request is for operational condition data only from identified ones of the sensors 112 that relate to the trap data (less than all sensors 112 within the printing machine). The external computerized device 130 sends the limited request to the processor 124 through the network 132.

The processor 124 then responds, through the network 132 to the external computerized device 130. More specifically, the processor 124 responds to the limited request with operational condition data only from the identified ones of the sensors 112 (by following the program of instructions of the device 130-resident web service).

The external computerized device 130 then determines the cause of the operational error from the operational condition data from the identified sensors 112 to produce a corrective solution to prevent the operational error from recurring in the future. The external computerized device 130 then sends the corrective solution to the processor 124 through the network 132. The processor 124 can then alter at least one settings of the printing machine (a non-volatile memory setting within the printing machine) as directed by the corrective solution.

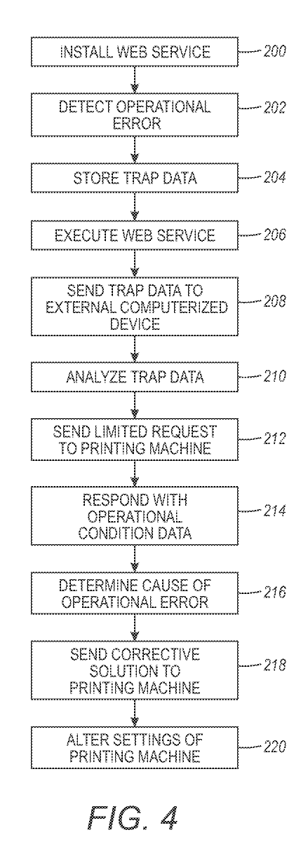

FIG. 4 is flowchart illustrating an exemplary method herein. In item 200, this method first installs a device-resident web service on the non-transitory storage medium of the printing machine. In item 202, the method detects (using the processor) an operational error of the printing machine and stores trap data (item 204) in the non-transitory storage medium when the operational error is detected. The trap data comprises information that the processor detected to identify the operational error.

When the operational error is detected the method executes (using the processor) in item 206 the device-resident web service to cause the processor to send the trap data to the external computerized device through the network connected to the network connection of the printing machine (item 208). The method next analyzes (using the external computerized device) the trap data to formulate a limited request for operational condition data from sensors of the printing machine in item 210. The limited request asks for operational condition data only from identified ones of the sensors that relate to the trap data. The method then sends the limited request from the external computerized device to the processor through the network in item 212.

The method then responds (using the processor through the network to the external computerized device) to the limited request with operational condition data only from the identified ones of the sensors in item 214. The method determines (using the external computerized device) a cause of the operational error from the operational condition data from the identified sensors to produce a corrective solution to prevent the operational error from recurring in item 216. Next, in item 218 the method sends, from the external computerized device, the corrective solution to the processor through the network. This allows the method to alter (using the processor) at least one setting of the printing machine as directed by the corrective solution in item 220.

Many computerized devices are discussed above. Computerized devices that include chip-based central processing units (CPU's), input/output devices (including graphic user interfaces (GUI), memories, comparators, processors, etc. are well-known and readily available devices produced by manufacturers such as Dell Computers, Round Rock Tex., USA and Apple Computer Co., Cupertino Calif., USA. Such computerized devices commonly include input/output devices, power supplies, processors, electronic storage memories, wiring, etc., the details of which are omitted herefrom to allow the reader to focus on the salient aspects of the embodiments described herein. Similarly, scanners and other similar peripheral equipment are available from Xerox Corporation, Norwalk, Conn., USA and the details of such devices are not discussed herein for purposes of brevity and reader focus.

The terms printer or printing device as used herein encompasses any apparatus, such as a digital copier, bookmaking machine, facsimile machine, multi-function machine, etc., which performs a print outputting function for any purpose. The details of printers, printing engines, etc., are well-known by those ordinarily skilled in the art and are discussed in, for example, U.S. Pat. No. 6,032,004, the complete disclosure of which is fully incorporated herein by reference. The embodiments herein can encompass embodiments that print in color, monochrome, or handle color or monochrome image data. All foregoing embodiments are specifically applicable to electrostatographic and/or xerographic machines and/or processes.

In addition, terms such as “right”, “left”, “vertical”, “horizontal”, “top”, “bottom”, “upper”, “lower”, “under”, “below”, “underlying”, “over”, “overlying”, “parallel”, “perpendicular”, etc., used herein are understood to be relative locations as they are oriented and illustrated in the drawings (unless otherwise indicated). Terms such as “touching”, “on”, “in direct contact”, “abutting”, “directly adjacent to”, etc., mean that at least one element physically contacts another element (without other elements separating the described elements). Further, the terms automated or automatically mean that once a process is started (by a machine or a user), one or more machines perform the process without further input from any user.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. The claims can encompass embodiments in hardware, software, and/or a combination thereof. Unless specifically defined in a specific claim itself, steps or components of the embodiments herein cannot be implied or imported from any above example as limitations to any particular order, number, position, size, shape, angle, color, or material.

What is claimed is:

1. A method comprising:
installing a device-resident web service on a printing machine;
detecting, by said processor, an operational error of said printing machine;
storing, in said printing machine, trap data when said operational error is detected, said trap data comprising information that said processor detected to identify said operational error;
executing, by said processor, said device-resident web service to cause said processor to send said trap data to an external computerized device through a network connected to a network connection of said printing machine;
receiving, from said external computerized device, a limited request for operational condition data from sensors of said printing machine, said limited request requesting operational condition data only from identified ones of said sensors that relate to said trap data;
responding, by said processor to said external computerized device, to said limited request with operational condition data only from said identified ones of said sensors;
receiving, from said external computerized device, a corrective solution to prevent said operational error from recurring; and
altering, by said processor, at least one setting of said printing machine as directed by said corrective solution.

2. The method according to claim 1, said identified ones of said sensors comprising less than all sensors within said printing machine.

3. The method according to claim 1, said responding to said limited request being performed by following instructions of said device-resident web service.

4. The method according to claim 1, said at least one setting of said printing machine comprising a non-volatile memory setting within said printing machine.

5. The method according to claim 1, said external computerized device comprising a device that is physically separate from said printing machine.

6. A method comprising:
installing a device-resident web service on a non-transitory storage medium of a printing machine, said device-resident web service comprising a program of instructions executable by a processor of said printing machine;
detecting, by said processor, an operational error of said printing machine;
storing, in said non-transitory storage medium, trap data when said operational error is detected, said trap data comprising information that said processor detected to identify said operational error;
executing, by said processor, said device-resident web service when said operational error is detected to cause said processor to send said trap data to an external computerized device through a network connected to a network connection of said printing machine;
analyzing, by said external computerized device, said trap data to formulate a limited request for operational condition data from sensors of said printing machine, said limited request requesting operational condition data only from identified ones of said sensors that relate to said trap data;
sending, by said external computerized device, said limited request to said processor through said network;
responding, by said processor through said network to said external computerized device, to said limited request with operational condition data only from said identified ones of said sensors;
determining, by said external computerized device, a cause of said operational error from said operational condition data from said identified sensors to produce a corrective solution to prevent said operational error from recurring;
sending, by said external computerized device, said corrective solution to said processor through said network; and
altering, by said processor, at least one setting of said printing machine as directed by said corrective solution.

7. The method according to claim 6, said identified ones of said sensors comprising less than all sensors within said printing machine.

8. The method according to claim 6, said responding to said limited request being performed by following said program of instructions of said device-resident web service.

9. The method according to claim 6, said at least one setting of said printing machine comprising a non-volatile memory setting within said printing machine.

10. The method according to claim 6, said external computerized device comprising a device that is physically separate from said printing machine.

11. A printing machine comprising:
a processor;
sensors operatively connected to said processor;
a non-transitory storage medium operatively connected to said processor;
a network connection operatively connected to said processor; and
a device-resident web service stored on said non-transitory storage medium, said device-resident web service comprising a program of instructions executable by said processor,
said processor detecting an operational error of said printing machine, said processor storing, in said printing machine, trap data when said operational error is detected,
said trap data comprising information that said processor detected to identify said operational error,
said processor executing said device-resident web service to cause said processor to send said trap data to an external computerized device through a network connected to said network connection;
said processor receiving, from said external computerized device, a limited request for operational condition data from said sensors of said printing machine,
said limited request requesting operational condition data only from identified ones of said sensors that relate to said trap data,
said processor responding, to said external computerized device, to said limited request with operational condition data only from said identified ones of said sensors,
said processor receiving, from said external computerized device, a corrective solution to prevent said operational error from recurring, and
said processor altering at least one setting of said printing machine as directed by said corrective solution.

12. The printing machine according to claim 11, said identified ones of said sensors comprising less than all sensors within said printing machine.

13. The printing machine according to claim 11, said responding to said limited request being performed by following said program of instructions of said device-resident web service.

14. The printing machine according to claim 11, said at least one setting of said printing machine comprising a non-volatile memory setting within said printing machine.

15. The printing machine according to claim 11, said external computerized device comprising a device that is physically separate from said printing machine.

16. A system comprising:
a printing machine comprising a processor, sensors operatively connected to said processor, a non-transitory storage medium operatively connected to said processor, and a network connection operatively connected to said processor;
an external computerized device operatively connected to said network connection through a network; and
a device-resident web service stored on said non-transitory storage medium, said device-resident web service comprising a program of instructions executable by said processor,
said processor detecting an operational error of said printing machine,
said processor storing, in said non-transitory storage medium, trap data when said operational error is detected,
said trap data comprising information that said processor detected to identify said operational error,
said processor executing said device-resident web service when said operational error is detected to cause said processor to send said trap data to said external computerized device through said network connected to said network connection of said printing machine;
said external computerized device analyzing said trap data to formulate a limited request for operational condition data from said sensors of said printing machine, said limited request requesting operational condition data only from identified ones of said sensors that relate to said trap data;
said external computerized device sending said limited request to said processor through said network;
said processor responding, through said network to said external computerized device, to said limited request with operational condition data only from said identified ones of said sensors;
said external computerized device determining a cause of said operational error from said operational condition data from said identified sensors to produce a corrective solution to prevent said operational error from recurring;
said external computerized device sending said corrective solution to said processor through said network; and
said processor altering at least one setting of said printing machine as directed by said corrective solution.

17. The system according to claim 16, said identified ones of said sensors comprising less than all sensors within said printing machine.

18. The system according to claim 16, said responding to said limited request being performed by following said program of instructions of said device-resident web service.

19. The system according to claim 16, said at least one setting of said printing machine comprising a non-volatile memory setting within said printing machine.

20. The system according to claim 16, said external computerized device comprising a device that is physically separate from said printing machine.
